(19) United States
(12) Patent Application Publication
(10) Pub. No.: US 2003/0177258 A1
(43) Pub. Date: Sep. 18, 2003

(54) Reconfigurable control processor for multi-protocol resilient packet ring processor

(75) Inventors: Paritosh Kulkarni, San Jose, CA (US); Roxanna Ganji, Fremont, CA (US); Nirmal Raj Saxena, Los Altos Hills, CA (US)

Correspondence Address: LaRiviere, Grubman & Payne, LLP, P.O. Box 3140, Monterey, CA, 93942, US

(73) Assignee: Chip Engines, Santa Clara, CA

(21) Appl. No.: 10/346,035

(22) Filed: Jan. 15, 2003

Related U.S. Application Data
(60) Provisional application No. 60/349,045, filed on Jan. 15, 2002.

(51) Int. Cl. G06F 15/173

(52) U.S. Cl. 709/236; 709/237; 709/238; 709/224

(57) ABSTRACT

A method and system for adaptive multi-protocol resilient packet ring (RPR) processing are provided. The present invention provides optimal handling operations targeted for both legacy and evolving RPR functions related to topology discovery, fairness algorithms, and control-packet manipulation. Further, the present invention utilizes out-band paths, unique data and instruction memory constructs, and pipeline and multi-thread features to provide wire-rate performance. In one embodiment, a system of the present invention includes instruction memory; a fetch unit associated with instruction memory; a decode unit associated with the fetch unit; at least one execution unit associated with the decode unit; a load/store unit associated with the at least one execution unit; and data memory associated with the load/store unit.

### RELATED APPLICATIONS

This application claims priority to the U.S. Provisional Patent Application Serial No. 60/349,045, filed Jan. 15, 2002, the entire content of which is incorporated herein.

### BACKGROUND OF THE INVENTION

1. Field of the Invention

The present invention relates generally to network processing systems; and, more particularly, to processors for fiber optic rings.

2. Description of the Background Art

Current network technology provides high-speed networks such as fiber optic rings for transmission of information as light impulses along a glass or plastic wire or fiber. Fiber optic wire carries much more information than conventional copper wire and is far less subject to electromagnetic interference. Fiber optic rings are widely deployed in both Metropolitan Area Networks (MANs) and wide area networks (WANs). These topologies, however, are currently dependent on protocols that are not optimized or scalable to meet the demands of packet-switched networks. For example, Resilient Packet Ring (RPR) is a network topology protocol with active redundancy for fiber optic rings, and includes ongoing development of working group IETF 802.17 for access control layer standards. The RPR working group attempts to address issues related to bandwidth allocation and throughput, speed of deployment and equipment and operational costs. RPR architectures preserve the resiliency to failures achievable in traditional Synchronous Optical Network (SONET) rings, and eliminate the bandwidth inefficiencies associated with Time-Division Multiplexing (TDM), passive redundancy, and lack of spatial reuse in SONET rings.

Of note, the ongoing development of the RPR working group brings about changes in several inherent aspects of RPR due to evolution of the standard as well as customer field experience. These aspects include topology discovery (topology discovery is a distributed processing protocol wherein every node in the RPR ring through an appropriate exchange of topology packets determine or discover their interconnection structure); fairness algorithm (fairness algorithm is a distributed algorithm wherein every node in the RPR ring collects usage statistics of other nodes using the shared ring bandwidth; and, by way of these statistics, each node determines if bandwidth provisions are being violated or if there is under-utilization of available bandwidth. This information is shared among all other nodes in the RPR ring via fairness control messages so that appropriate action is taken on a per node basis); bandwidth management (bandwidth management is a mechanism of specifying at each RPR node the bandwidth requirements of all other nodes in the RPR ring; bandwidth management works in conjunction with topology discovery and fairness algorithms); and data and control packet formats definitions. These changes may negatively impact existing areas of network management and control. For example, Application Specific Integrated Circuit (ASIC) packet processing solutions for legacy RPR protocols are not designed to cope with changes in the existing RPR protocol. Network-processor based solutions are not able to meet the wire-rate performance demanded by OC-192 or 10G Ethernet rings due to stringent budgets in instruction set timing. Field Programmable Gate Array (FPGA) solutions provide flexibility in synthesizing logic and memory structures optimized for different RPR protocols. In OC-192 or 10G Ethernet Rings, however, internal memory requirements for transit and insert buffers exceed the capacity of commercially-available FPGAs. Incorporation of SONET and MAC framers put enormous demands on the capacity of FPGAs. Due to logic complexity and limitations of synthesis and placement tools, the clock speed is not sufficient to meet wire-rate performance required by OC-192 or 10G links. In some instances, the use of multiple FPGAs (usually of an order of magnitude greater than ASICs or Network Processors) mitigates some of the aforementioned issues; however, the costs associated with such an implementation significantly undermine profit margins for the system manufacturers and downstream consumers.

What is needed, therefore, is a cost-efficient network processing solution for fiber optic rings with optimal bandwidth efficiency and wire-rate performance as well as resiliency to failures. Further, it is desirable to provide flexibility with regard to various protocol aspects.

### BRIEF SUMMARY OF THE INVENTION

The present invention addresses the issue of the prior art and current art with a system and method for adaptive RPR processing. The system and method of the present invention provide optimal handling operations targeted for legacy RPR functions and evolving RPR functions related to topology discovery, fairness algorithms, and control-packet manipulation, while maintaining failure resilience and optimizing bandwidth efficiency. Further, the present invention utilizes out-band paths, unique data and instruction memory constructs, and pipeline and multi-thread features to provide wire-rate performance at OC-102 and 10G Ethernet line speeds.

In one embodiment of the present invention, an adaptive RPR processor system includes instruction memory; a fetch unit associated with instruction memory; a decode unit associated with the fetch unit; at least one execution unit associated with the decode unit; a load/store unit associated with the at least one execution unit; and data memory associated with the load/store component.

In another embodiment of the present invention, a method for adaptive RPR processing includes the steps of providing instruction memory; providing a specialized instruction set associated with instruction memory; upon a periodic trigger, a periodic event or an arriving packet, fetching at least one instruction from the instruction set in instruction memory with a fetch unit; decoding the at least one instruction with a decode unit associated with the fetch unit; executing the at least one instruction with at least one execution unit associated with the decode unit; loading and storing data from and to data memory via a load/store unit associated with the at least one execution unit; carrying packet-related information via a first out-band path associated with the at least one execution unit; and carrying information related to RPR-related functions via at least one second out-band path between the load/store unit and at least one out-band configurable logic component.

Further advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

FIG. 1 illustrates an adaptive multi-protocol resilient packet ring processor according to the present invention; and

FIG. 2 illustrates a method for an adaptive multi-protocol resilient packet ring processing according to the present invention.

### DETAILED DESCRIPTION OF THE INVENTION

The present invention utilizes unique component and processing constructs to enable optimal processing results, maximize bandwidth allocation, and maximize throughput while enveloping multiple protocols. The pipelining and multi-threaded features of the method and system disclosed herein enhance continuous processing operations and provide wire-rate performances; e.g., OC-192 and 10G line speeds.

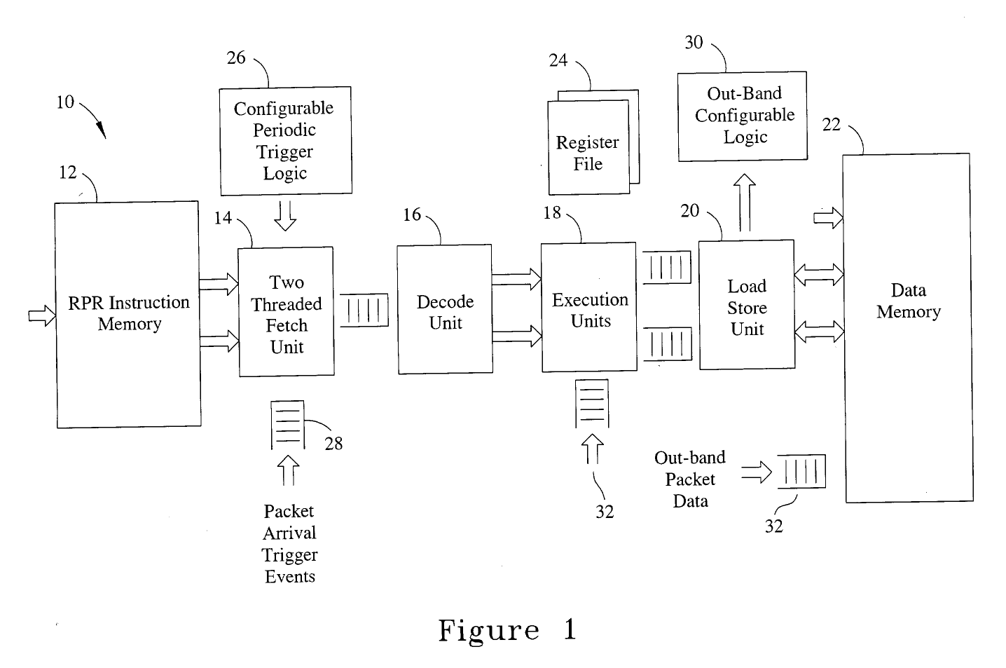

Turning now to the drawings, wherein like figures are referenced with like numerals, there is shown in FIG. 1 and generally at 10 a resilient packet ring processor according to the present invention having instruction memory 12, a fetch unit 14, a decode unit 16, at least one execution unit 18, a load/store unit 20, and data memory 22. A register file 24 is affiliated therewith.

Instruction memory 12 contains an associated instruction set, not shown, conducive to RPR operations; i.e., a specialized instruction set optimized to handle operations as they relate to processing functions associated with RPR functionality (discussed hereinafter). The fetch unit 14, preferably two-threaded, fetches instructions from instruction memory 12 for decoding in the decode unit 16 and executing in the execution unit 18. In various embodiments of the present invention, the fetch unit 14 is defined by a configurable periodic logic component 26, is triggered by packet arrival trigger events 28, is triggered by periodic events (not illustrated), or a combination of the foregoing. The fetch unit 14 provides a continuous instruction stream from instruction memory 12 to the decode unit 16 for decoding and execution in the execution unit 18. The execution unit 18 includes the functionality necessary to process operations targeted for RPR-functions; e.g., topology discovery, fairness algorithms, and control packet manipulation. Topology discovery needs to be efficiently executed in order to rapidly determine changes arising to due node addition and deletion in the RPR ring. Fairness algorithms also need to be executed efficiently in order to rapidly respond to events that cause excessive use or underutilization of provisioned bandwidth. Control packet manipulation requires bit level extraction and modification. Different RPR protocols require different topology discovery, different fairness algorithms, and different packet formats. The load/store unit 20 interacts with the data memory 22 to stage or store data therefrom and thereto. Such efficient pipelining and execution in parallel of the instructions in the instruction set maximize system performance and throughput.

Various embodiments of the present system provide further performance enhancement via communication paths for one or more out-band reconfigurable logic components 30. The out-band reconfigurable logic component 30 may be designed for RPR-specific functions, which are communicated to load/store unit 20 via the aforementioned path, thus permitting simultaneous processor operations among system components. For example, the RPR-specific functions may include low-pass filtering and rate metering functions to collect usage statistics; packet formatting functions for various control, topology and fairness packets; protocol-specific bit manipulation, error checking and correction functions.

Certain embodiments also include one or more paths for out-band packet data 32, to allow full utilization of the execution unit 18 during processing operations. The out-band packet data 32 may comprise, for example, information about packet size and flow-id and may be synchronized with the instruction steam associated with a particular flow-id. Such data utilizes said paths for communicating with the execution unit 18.

Finally, in various embodiments of the system, instruction memory 12, data memory 22, the register file 24 and out-band reconfigurable logic components 30 allow access not only through the aforementioned processor units, but through external agents, as well. The external agents include, for example, rate calculators, cyclic redundancy check compute engines, packet queue level indicators, and schedulers that share logic and register state with the aforementioned processor units in the reconfigurable logic components. For example, use of reconfigurable logic components enables implementation of any packet scheduling algorithm without impacting the wire-rate packet performance.

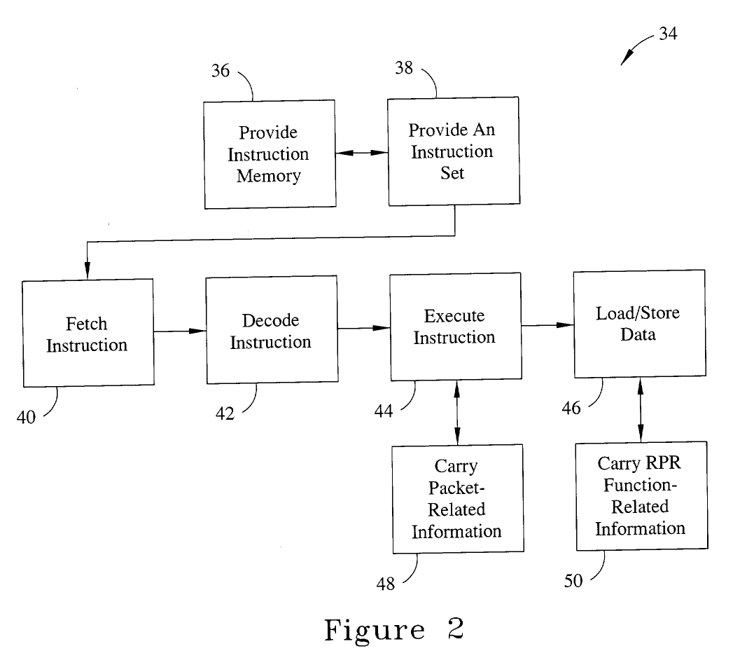

Turning now to FIG. 2, there is shown generally at 34 a method for multi-protocol resilient packet ring processing which includes the steps of providing instruction memory 36, providing a specialized instruction set associated with instruction memory 38; upon a periodic trigger, a periodic event or an arriving packet, fetching at least one instruction from the instruction set in instruction memory with a fetch unit 40; decoding the at least one instruction with a decode unit associated with the fetch unit 42; executing the at least one instruction with at least one execution unit associated with the decode unit 44; loading and storing data from and to data memory via a load/store unit associated with the at least one execution unit 46; carrying packet-related information via a first out-band path associated with the at least one execution unit 48; and carrying information related to RPR-related functions via at least one second out-band path between the load/store unit and at least one out-band reconfigurable logic component 50. Steps 40-50 may be accomplished serially, in parallel, or a combination thereof.

Having illustrated and described the principles of the system and method of the present invention in various embodiments, it should be apparent to those skilled in the art that the embodiment can be modified in arrangement and detail without departing from such principles. For example, the physical manifestation of system media may be changed if preferred. Therefore, the illustrated embodiments should be considered only as example of the invention and not as a limitation on its scope. Although the description above contains much specificity, this should not be construed as limiting the scope of the invention but as merely providing illustrations of some of the presently preferred embodiments of this invention. Further, it is appreciated that the scope of the present invention encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claim. No claim element herein is to be construed under the provisions of 35 U.S.C. 112, sixth paragraph, unless the element is expressly recited using the phrase “means for”.

What is claimed is:

1. A system for adaptive multi-protocol resilient packet ring processing comprising:
instruction memory;
a fetch unit associated with instruction memory;
a decode unit associated with the fetch unit;
at least one execution unit associated with the decode unit;
a load/store unit associated with the at least one execution unit; and
data memory associated with the load/store unit.

2. The system of claim 1, further comprising a specialized instruction set associated with instruction memory.

3. The system of claim 1, further comprising a register file associated with the at least one execution unit.

4. The system of claim 1, wherein the fetch unit further comprises a multi-threaded fetch unit.

5. The system of claim 4, further comprising a configurable periodic logic component associated with the multi-threaded fetch unit.

6. The system of claim 4, further comprising periodic events triggering the multi-threaded fetch unit.

7. The system of claim 4, further comprising packet arrival events triggering the multi-threaded fetch unit.

8. The system of claim 1, further comprising operations targeted for at least one RPR function selected from the group consisting essentially of topology discovery functions, fairness algorithms, and control-packet manipulation functions, the operations associated with the at least one execution unit.

9. The system of claim 1, further comprising a first out-band path for carrying packet-related information, the out-band path associated with the at least one execution unit.

10. The system of claim 1, further comprising at least one second out-band path for communicating with an out-band reconfigurable logic component, the at least one second out-band path associated with the load/store unit.

11. The system of claim 10, wherein the out-band reconfigurable logic component further comprises at least one RPR function.

12. The system of claim 10, further comprising at least one external agent associated with at least one element selected from the group consisting essentially of data memory, instruction memory, the out-band reconfigurable logic component and the register file.

13. A system for adaptive multi-protocol resilient packet ring processing comprising:
instruction memory;
a specilized instruction set associated with instruction memory;
a two-threaded fetch unit associated with instruction memory;
at least one component selected from a group consisting essentially of a configurable periodic logic component, periodic events triggering the two-threaded fetch unit, and packet arrival events triggering the two-threaded fetch unit;
a decode unit associated with the fetch unit;
at least one execution unit associated with the decode unit;
a first out-band path for carrying packet-related information, the out-band path associated with the at least one execution unit;
a register file associated with the at least one execution unit;
a load/store unit associated with the at least one execution unit;
at least one second out-band path for communicating with at least one out-band reconfigurable logic component, the at least one second out-band path associated with the load/store unit; and
data memory associated with the load/store unit.

14. The system of claim 13 further comprising operations targeted for at least one RPR function selected from the group consisting essentially of topology discovery functions, fairness algorithms, and control-packet manipulation functions, the operations associated with the at least one execution unit.

15. The system of claim 13 wherein the out-band reconfigurable logic component further comprises at least one RPR function.

16. The system of claim 13 further comprising at least one external agent associated with at least one element selected from the group consisting essentially of data memory, instruction memory, the out-band reconfigurable logic component and the register file.

17. A method for adaptive multi-protocol resilient packet ring processing comprising:
providing instruction memory;
providing a specialized instruction set associated with instruction memory; performing the following steps in parallel, serially, or a combination thereof:
upon a periodic trigger, a periodic event or an arriving packet, fetching at least one instruction from the instruction set in instruction memory with a fetch unit;
decoding the at least one instruction with a decode unit associated with the fetch unit;
executing the at least one instruction with at least one execution unit associated with the decode unit;
loading and storing data from and to data memory via a load/store unit associated with the at least one execution unit;
carrying packet-related information via a first out-band path associated with the at least one execution unit; and
carrying information related to RPR-related functions via at least one second out-band path between the load/store unit and at least one out-band reconfigurable logic unit.

18. The method of claim 17, further comprising the step of providing a register file associated with the at least one execution unit.

19. The method of claim 17, further comprising the step of providing operations targeted for at least one RPR function, the operations selected from the group consisting essentially of topology discovery functions, fairness algorithms, and control-packet manipulation functions, the operations associated with the at least one execution unit.

20. The method of claim 18, further comprising at least one external agent associated with at least one element selected from the group consisting essentially of data memory, instruction memory, the at least one out-band reconfigurable logic component, and the register file.
